(19) United States
(12) Patent Application Publication
(10) Pub. No.: US 2017/0361829 A1
(43) Pub. Date: Dec. 21, 2017

(54) MULTI-ENGINE POWERTRAIN CONTROL SYSTEM APPARATUS AND METHOD

(71) Applicant: John W. Nicholson, IV, New Orleans, LA (US)

(72) Inventor: John W. Nicholson, IV, New Orleans, LA (US)

(21) Appl. No.: 15/188,508

(22) Filed: Jun. 21, 2016

(51) Int. Cl. B60W 20/10; B60W 10/08; B60W 10/04; B60W 50/14; B60K 6/00; B60W 10/06; B63H 21/20; B60W 10/02

(52) U.S. Cl. CPC B60W 20/10; B63H 21/20; B60W 10/08; B60W 10/02; B60W 50/14; B60K 6/00; B60W 10/06; B60W 10/04; B60W 2520/16; B60W 2710/021

(57) ABSTRACT

A multi-engine powertrain control system apparatus and method for activating and engaging a second, third, fourth, or more engines into a powertrain of a vehicle, vessel, or powerhouse, while running, without interruption, as needed under changing conditions requiring more power, and disengaging and de-activating engines when not needed, in order to conserve energy. The invention further provides real-time sensing of powertrain conditions and external conditions, provides pre-set parameters with user override, provides automatic engagement and disengagement based on real-time conditions, and provides for continued operation in the event of an engine's failure.

### BACKGROUND

This invention provides a multi-engine powertrain control system apparatus and method for activating and engaging a second, third, fourth, or more engines into a powertrain of a vehicle, vessel, or powerhouse, while running, without interruption, as needed under changing conditions requiring more power, and for disengaging and de-activating engines when not needed, in order to conserve energy.

Vehicles, vessels, or powerhouses, such as transportable electricity-generating devices, especially in military or emergency-response uses, are presently reliant on the performance of a single engine. This single engine is likely to be either underpowered for meeting occasional and sudden needs for a great deal of power, or overpowered, and therefore wasteful of fuel, for the greater part of the time when extreme power is unnecessary.

Another problem with a single engine is that an engine failure at an inopportune time will completely disable the vehicle, vessel, or powerhouse, possibly leaving personnel with no ability to complete a task or take evasive action. For example, a military vehicle or vessel making a routine patrol along established roads or routes might suddenly encounter a situation requiring a great amount of power to climb a steeper incline or achieve a greater speed.

There is therefore a need for a system that allows the use of one engine for basic operation of a vehicle, vessel, or powerhouse, but quickly adds additional power from additional engines to the powertrain when the additional power is needed.

### SUMMARY OF THE INVENTION

This invention provides a multi-engine powertrain control system apparatus and method for activating and engaging a second, third, fourth, or more engines into a powertrain of a vehicle, vessel, or powerhouse, while running, without interruption, as needed under changing conditions requiring more power, and disengaging and de-activating engines when not needed, in order to conserve energy. The invention further provides real-time sensing of powertrain conditions and external conditions, provides pre-set parameters with user override, provides automatic engagement and disengagement based on real-time conditions, and provides for continued operation in the event of an engine's failure.

The multi-engine powertrain control system of the invention monitors fuel mixture and engine speed by mean of a crankshaft or output shaft position sensor for engine speed, and throttle and injector pulse time for fuel mixture. If the computer detects a loss of engine speed while passing a specified value of fuel and air mixture, while in a specified gear if one exists, then the computer system will begin engaging secondary, tertiary, and higher systems until the engine speed meets or exceeds the commands of the powertrain control system input by driver while in such specified gear. The system engages each system first by starting another engine that is in the drivetrain (powertrain) driveline, second by increasing RPM (engine speed) to match Primary Engine RPM, and third by engaging a clutch or mating system synchronizing the simultaneous function of each engine. The system disengages and turns off each engine as the powertrain load is relieved, thus allowing for a more maximized fuel economy. This automated system is able to operate with more or less engines at any reasonable time as needed. There may also be an electronic or manual override to maintain one or more engines as driver commands.

### BRIEF DESCRIPTION OF DRAWINGS

Reference will now be made to the drawings, wherein like parts are designated by like numerals, and wherein:

FIG. 1 is a schematic view of an embodiment of the multi-engine powertrain control system of the invention;

FIG. 2 is a schematic top view of an embodiment of the multi-engine powertrain control system of the invention with primary and secondary engines running and engaged;

FIG. 3 is a schematic top view of an embodiment of the multi-engine powertrain control system of the invention with secondary engine not running and not engaged;

FIG. 4 is a schematic top view of an embodiment of the multi-engine powertrain control system of the invention with secondary engine running and not engaged;

FIG. 5 is a schematic top view of an embodiment of the multi-engine powertrain control system of the invention with two engines running and engaged;

FIG. 6 is a side view of an embodiment of the multi-engine powertrain control system of the invention, showing two engines;

FIG. 7 is a side view of an embodiment of the multi-engine powertrain control system of the invention, showing two engines and a torque-coupler-clutch between;

FIG. 8 is a perspective view of an embodiment of the multi-engine powertrain control system of the invention, showing two engines;

FIG. 9 is a perspective view of an embodiment of the multi-engine powertrain control system of the invention, showing two engines and a torque-coupler-clutch between;

FIG. 10 is a side view of another embodiment of the multi-engine powertrain control system of the invention, showing two engines;

FIG. 11 is a side view of another embodiment of the multi-engine powertrain control system of the invention, showing two engines and a torque-coupler-clutch between;

FIG. 12 is a perspective view of another embodiment of the multi-engine powertrain control system of the invention, showing two engines;

FIG. 13 is a perspective view of another embodiment of the multi-engine powertrain control system of the invention, showing two engines and a torque-coupler-clutch between;

FIG. 14 is a perspective view of another embodiment of the multi-engine powertrain control system of the invention having a mechanical torque-coupler-clutch;

FIG. 15 is an exploded perspective view of another embodiment of the multi-engine powertrain control system of the invention having a mechanical torque-coupler-clutch;

FIG. 16 is a perspective view of another embodiment of the multi-engine powertrain control system of the invention having four engines and three mechanical torque-coupler-clutches;

FIG. 17 is an exploded perspective view of another embodiment of the multi-engine powertrain control system of the invention having four engines and three mechanical torque-coupler-clutches;

FIG. 18 is a perspective view of another embodiment of the multi-engine powertrain control system of the invention having four engines and three mechanical torque-coupler-clutches;

FIG. 19 is a side view of another embodiment of the multi-engine powertrain control system of the invention having one internal-combustion and one electric engine; and

FIG. 20 is a flowchart representation of the control system of an embodiment of the multi-engine powertrain control system of the invention.

### DETAILED DESCRIPTION OF THE INVENTION

Referring to all figures generally, embodiments of the multi-engine powertrain control system 100 apparatus and method are illustrated.

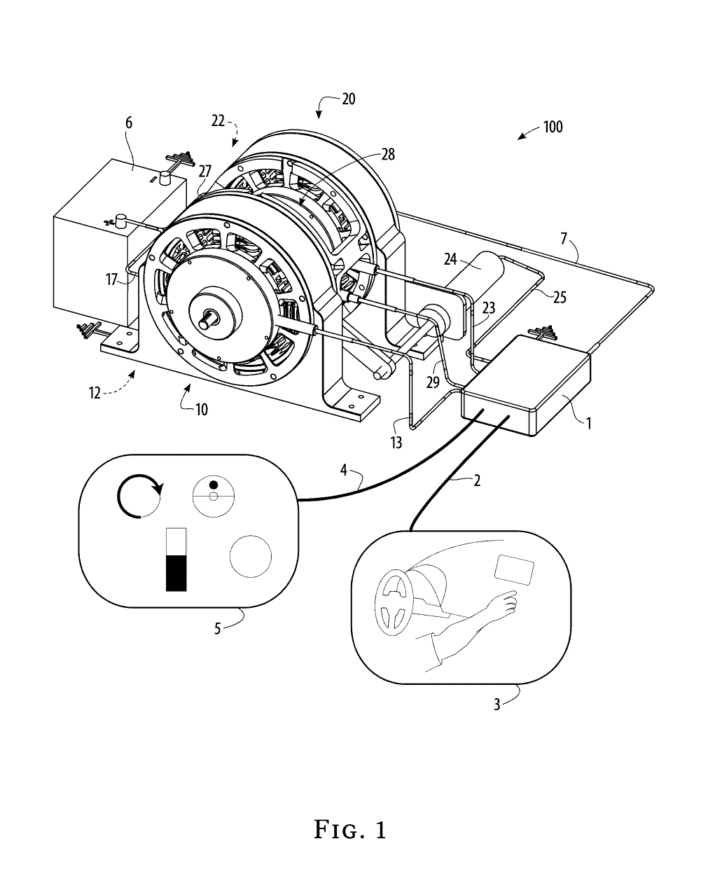

Referring to FIG. 1, a controller 1 receives real-time information from, and sends commands, information, and power to, the other components as disclosed herein. The controller 1 can be implemented on a computer. The controller 1 applies user-adjustable parameters to real-time information about powertrain conditions and operating conditions, and determines whether an additional engine is available and needed in the powertrain, and, if not, whether the powertrain is overpowered in excess of a user-adjustable allowance, and therefore an engine should be disengaged from the powertrain. The present power is determined from real-time information about performance of the engines engaged with the powertrain and performance of the powertrain. The needed power is determined from real-time information about the performance and operating conditions of the vehicle, vessel, or powerhouse. If present power is less than needed power, then another engine, if available, is engaged in the powertrain. If present power is greater than needed power in excess of a user-adjustable allowance, then an engine should be disengaged from the powertrain, if more than one engine is engaged. A flowchart of this process is shown as FIG. 20.

Referring still to FIG. 1, a user-console communication channel 2 connects the controller 1 with a user console 3. The user console 3 displays information to the driver, pilot, or operator about the state of the system, and accepts user input to, for example, adjust the allowance. The user-console communication channel 2 can be a wire or cable or bundle of wires, wireless communication, or a component of a communications bus.

A sensor-group communication channel 4 connects the controller 1 with a sensor group 5. The sensor group 5 includes sensors to determine, in real time, the RPMs and available power in the powertrain, and the operating conditions and load under which the vehicle, vessel, or powerhouse are working. The conditions to be monitored vary in significance among types of vehicles, vessels, and powerhouses, and the specific uses to which each is intended to be put. For example, in a heavy vehicle such as an armored vehicle or transport, the pitch, or angle of incline or decline, is important because going up a steep grade fully loaded requires a great deal of power. A vessel traveling on the water's surface, in contrast, is not called upon to travel up inclines. However, the pitch of such a vessel relative to the waterline might affect displacement or hydrodynamic properties enough to influence the need for more or less power. The conditions to be monitored also vary in significance among types of engines used in a vehicle, vessel, or powerhouse. For example, the availability of high torque at low speed is less for a standard internal-combustion engine than for an electric engine or motor. A climb up a steep grade at a given speed would therefore overwhelm a first or primary internal-combustion engine at a different point than would be the case with an electric engine.

A battery 6 provides the power for operation of the multi-engine powertrain control system 100, as distinct from the drive power of the powertrain. A controller power lead 7 conveys this power to the controller 1.

In the embodiment illustrated in FIG. 1, a primary engine 10 and a secondary engine 20 are shown. Each engine has a control lead 13, 23 over which the controller 1 can receive information from, and send commands for activation and deactivation to, the associated engine. An engine-starter control lead 17, 27 allows the controller 1 to start any type of engine that uses a separate starter. The associated engine starters 12, 22 are hidden in FIG. 1 but are shown in subsequent drawings.

Each additional engine, after the primary engine, has an associated torque-coupler-clutch assembly, or a continuous variable transmission (CVT). Illustrated in FIG. 1 are the secondary engine 20, the secondary torque-coupler-clutch activator 24, the secondary torque-coupler-clutch activator control lead 25, the secondary-engine-starter control lead 27, the secondary torque-coupler-clutch 28, and the secondary torque-coupler-clutch control lead 29. The torque-coupler-clutch 28 affects the engagement or disengagement of the associated engine from the powertrain. The torque-coupler-clutch can be an electromagnetic, hydraulic, or pneumatic clutch and drive, or can be a fluid-drive system, or mechanical.

In use, when a secondary engine 20 or additional engine is desired to be brought into the powertrain, the controller 1 activates the secondary-engine starter 22 via the secondary-engine-starter control lead 27, while sending the appropriate commands or signals to the secondary engine 20 over the secondary-engine control lead 23. The engine starts and is brought up to speed, as monitored over the secondary-engine control lead 23. When the engine is ready, the controller 1 energizes the secondary torque-coupler-clutch activator 24 via the secondary torque-coupler-clutch activator control lead 25. The secondary torque-coupler-clutch 28 engages the secondary engine 20 with the powertrain in the way appropriate for the type of torque-coupler-clutch used. A hydraulically activated mechanical clutch is illustrated. The controller controls and monitors the secondary torque-coupler-clutch 28 via the secondary torque-coupler-clutch control lead 29.

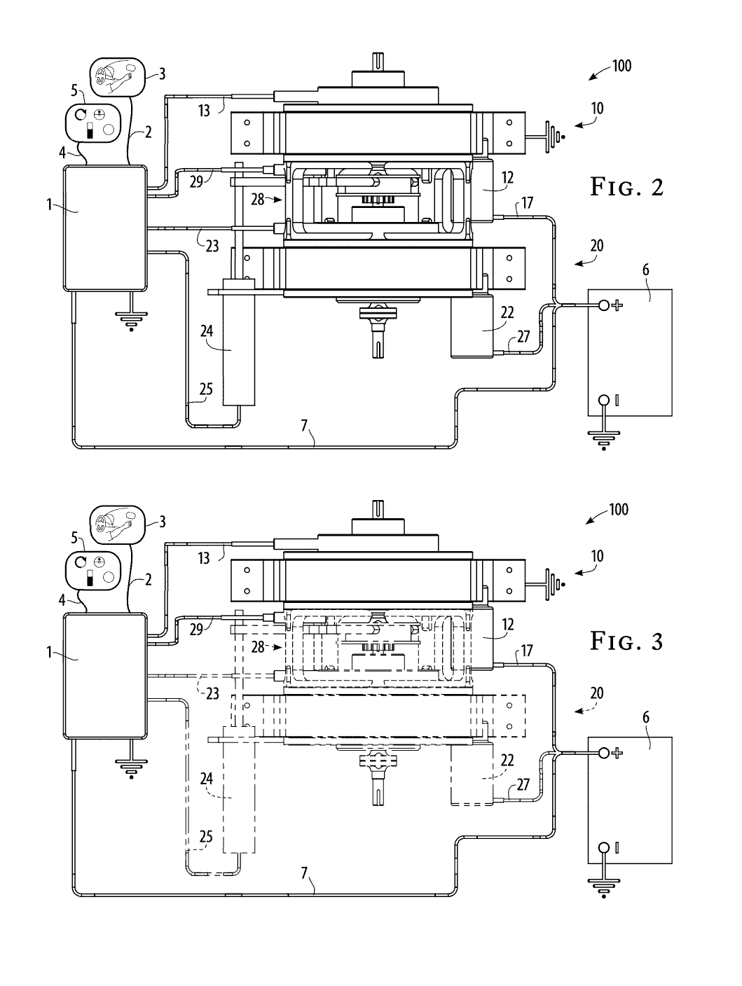

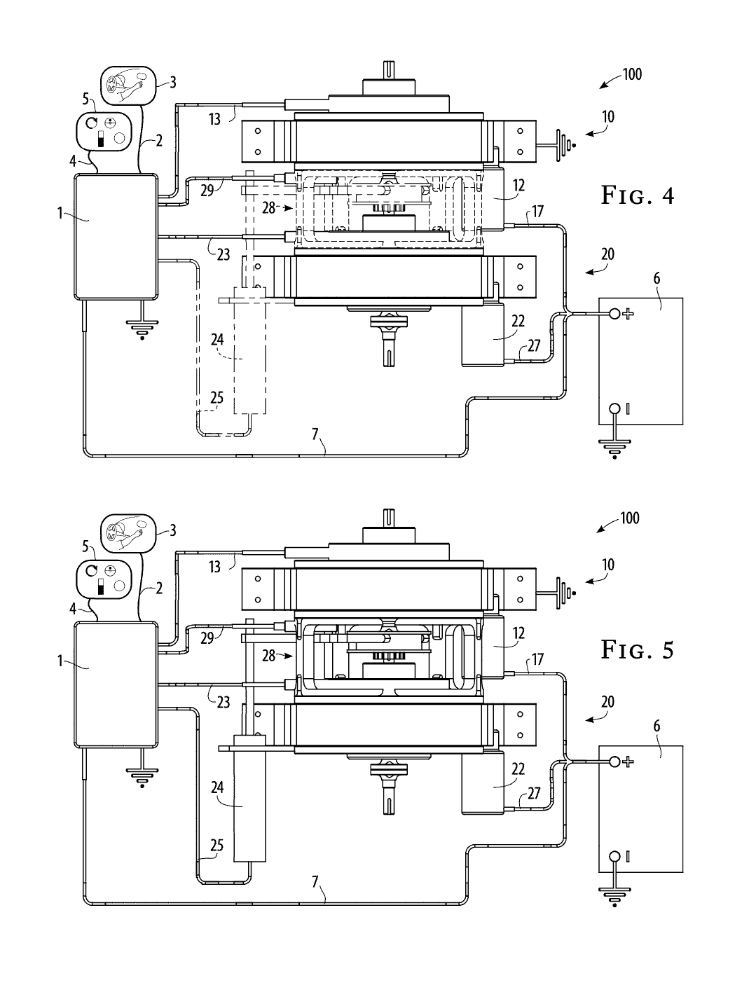

FIG. 2 illustrates the components of a two-engine embodiment having a primary-engine starter 12 and a secondary-engine starter 22. FIG. 3 illustrates the system with the secondary engine 20 and the secondary torque-coupler-clutch disengaged. FIG. 4 illustrates the system with the secondary engine 20 started and running, before the engagement of the secondary torque-coupler-clutch 28. FIG. 5 illustrates the system with both the secondary engine 20 and the secondary torque-coupler-clutch 28 engaged with and providing drive power to the powertrain.

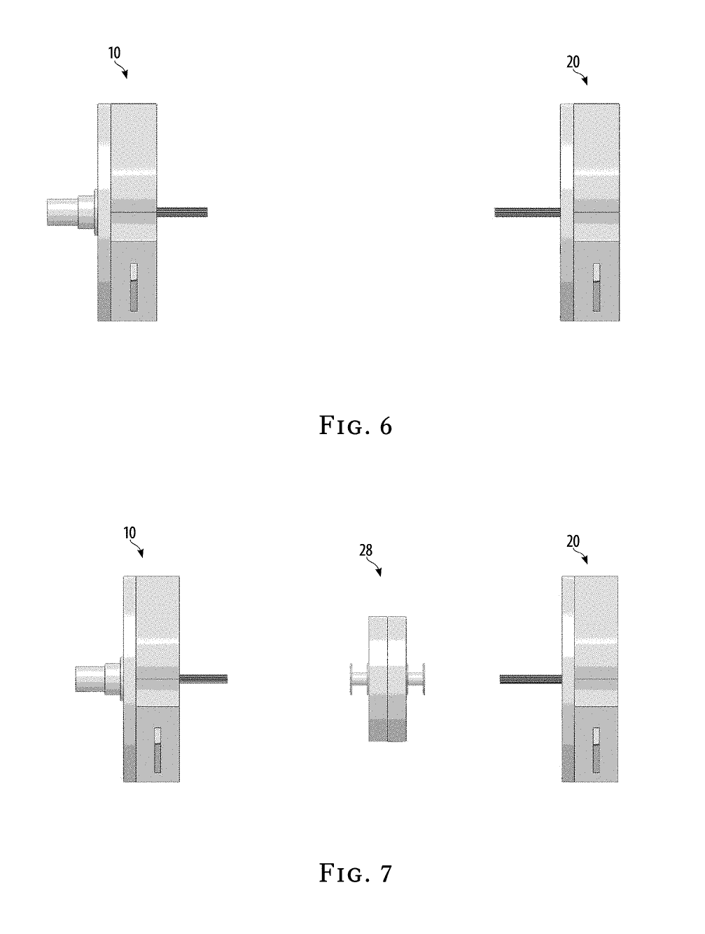

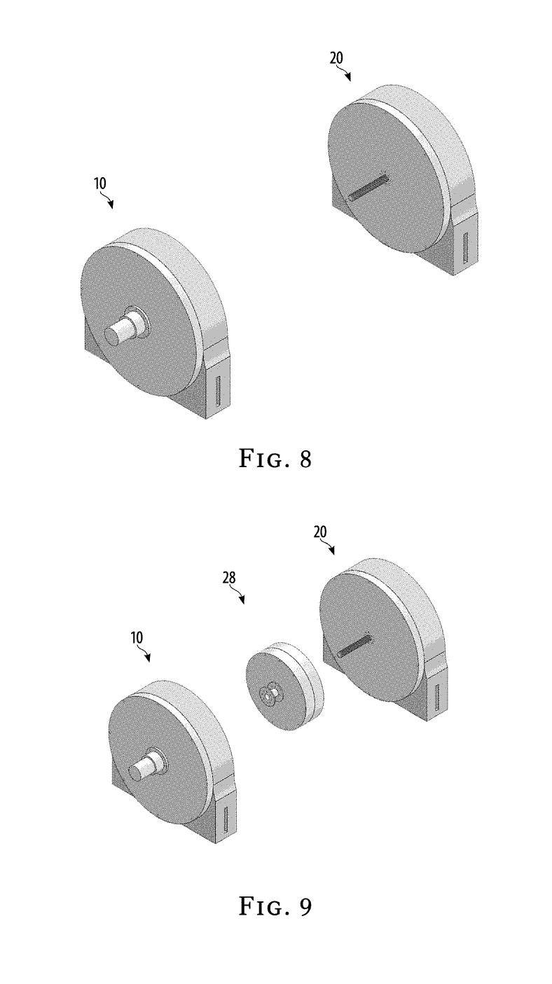

Referring to FIG. 6 and FIG. 7, an embodiment having an electric primary engine 10, an electric secondary engine 20, and a secondary torque-coupler-clutch 28 is illustrated. FIG. 8 and FIG. 9 are perspective views of the same embodiment.

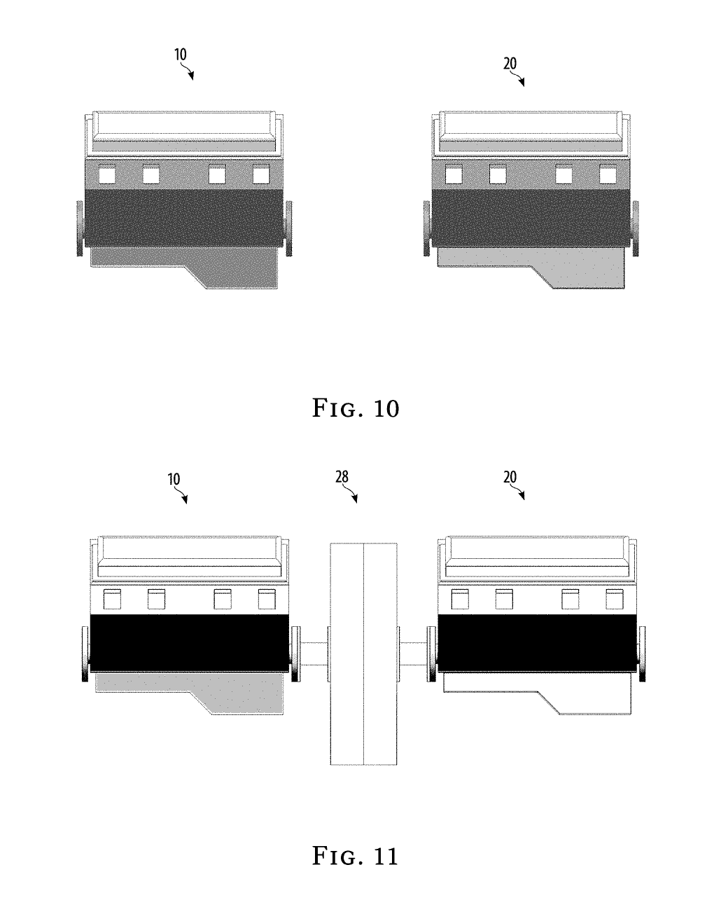

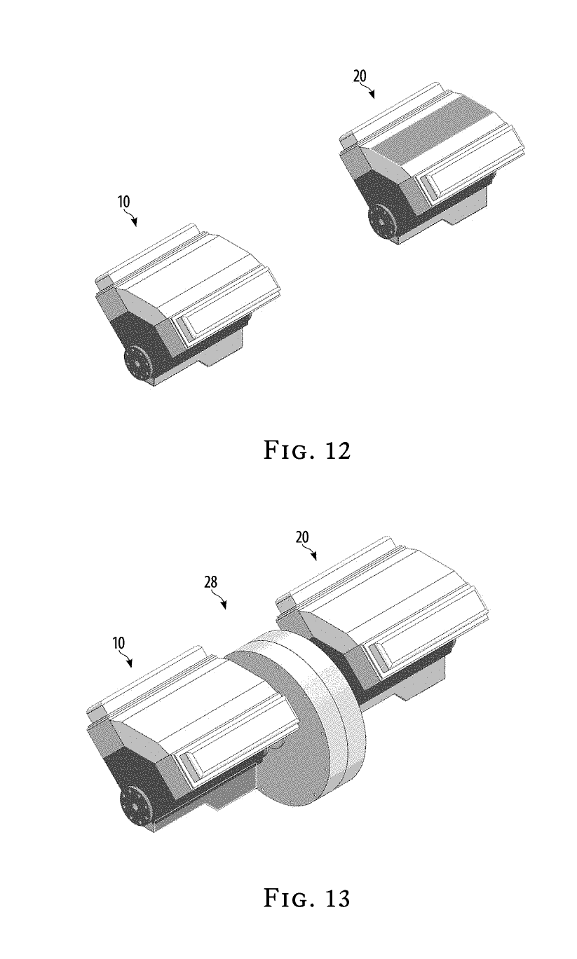

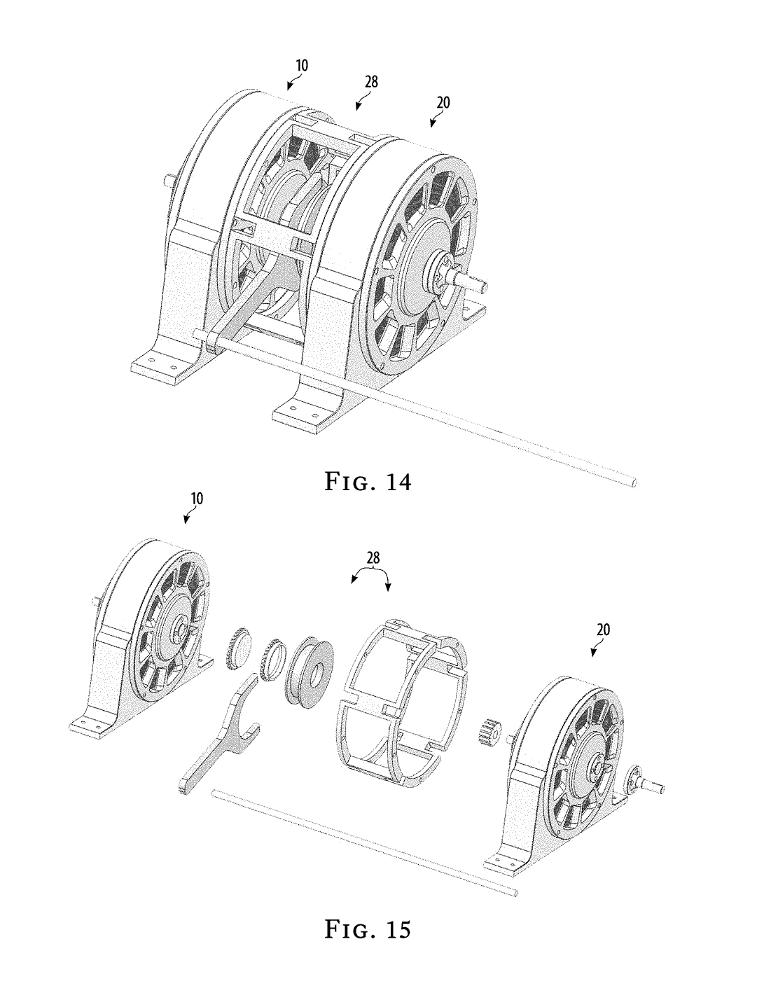

Referring to FIG. 10 and FIG. 11, an embodiment having an internal-combustion primary engine 10, an internal-combustion secondary engine 20, and a secondary torque-coupler-clutch 28 is illustrated. FIG. 12 and FIG. 13 are perspective views of the same embodiment.

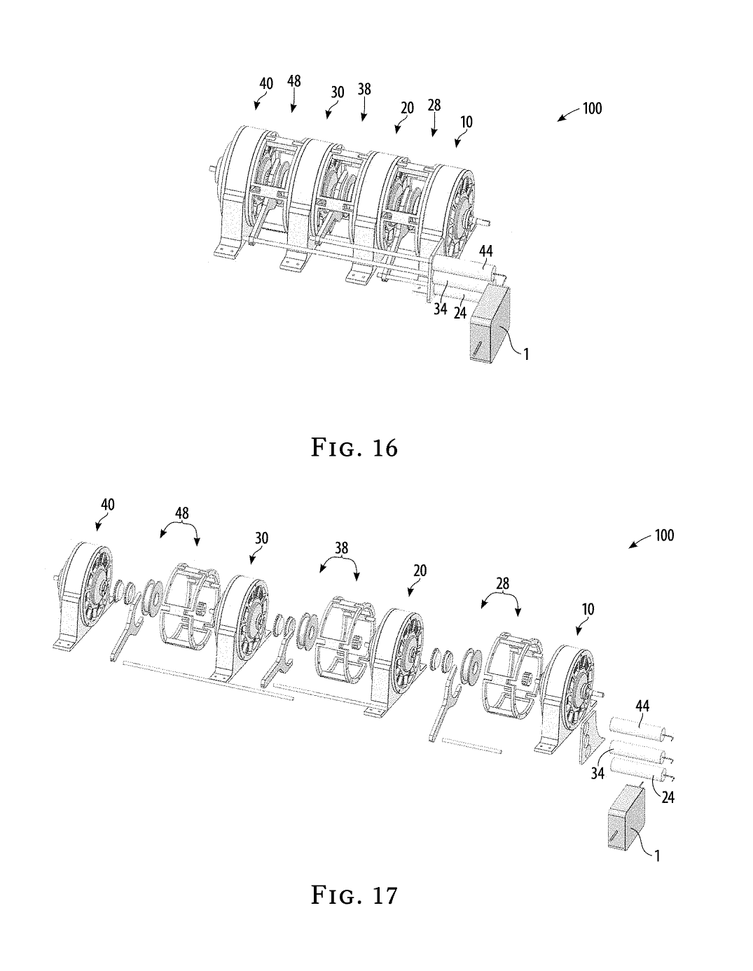

FIG. 14 and FIG. 15 illustrate an embodiment of the multi-engine powertrain control system having two electric engines 10, 20 and a mechanical secondary torque-coupler-clutch 28.

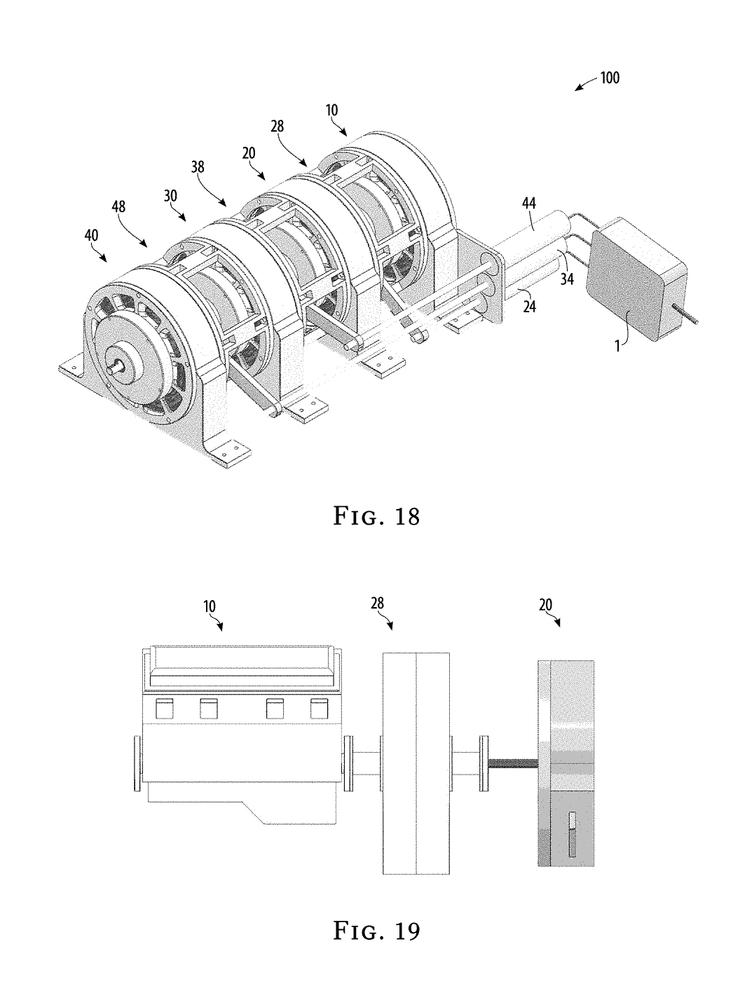

FIG. 16, FIG. 17, and FIG. 18 illustrate an embodiment of the multi-engine powertrain control system having four electric engines 10, 20, 30, 40 and three mechanical torque-coupler-clutches 28, 38, 48 with associated torque-coupler-clutch activators 24, 34, 44. Such an embodiment provides a great amount of control over the use of minimal fuel or electrical resources during routine operation versus the use of the available significant additional power, which can be engaged into the powertrain very quickly and automatically when needed.

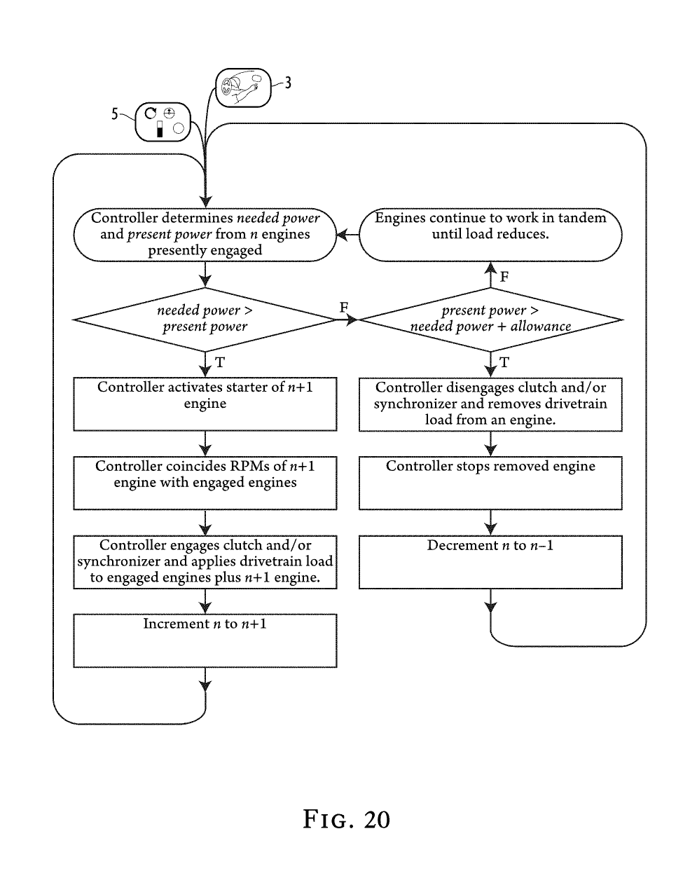

Referring to FIG. 19, the multi-engine powertrain control system can be used with primary, secondary, tertiary, and additional engines of different types. Advantages of using such an embodiment include the ability to draw upon a variety of fuel or energy sources in order to accommodate, for instance, the lack of availability of gasoline or compressed gas, or the lack of facilities or opportunity for recharging electric batteries. Another advantage of this different-engine-types embodiment is that the occasionally needed performance advantages of one engine type, such as the high-torque-at-low-speed advantages of electric engines, can be made available even where the primary engine is, for example, an internal-combustion engine capable of being refueled more quickly and easily.

Many changes and modifications can be made in the present invention without departing from the spirit thereof. I therefore pray that rights to the present invention be limited only by the scope of the appended claims.

What is claimed is:

1. A multi-engine powertrain control system apparatus for a vehicle, vessel, or powerhouse having a powertrain, operated by a user, driver, pilot, or operator, the multi-engine powertrain control system comprising:
(i) a primary engine having the sequence number n=1, adapted to drive the powertrain;
(ii) at least one additional engine, each having a sequence number n incrementally greater than 1, where nmax equals the total number of engines;
(iii) nmax number of engine starters, each associated with one said engine;
(iv) nmax-1 number of torque-coupler-clutches, each associated with one said additional engine, adapted to couple and uncouple the driving power of each associated said additional engine to the powertrain;
(v) nmax-1 number of torque-coupler-clutch activators, each associated with one said torque-coupler-clutch, adapted to change the coupled or uncoupled state of each associated said torque-coupler-clutch;
(vi) a controller adapted to sense the powertrain's conditions and control said additional engines, engine starters, torque-coupler-clutches, and torque-coupler-clutch activators, in real time, based on powertrain conditions and user-adjustable parameters of operation;
(vii) a user console adapted to display information to and accept commands from a user in real time;
(viii) a user-console communication channel adapted to convey information or power between said controller and said user console;
(ix) a sensor group adapted to monitor the performance of the powertrain and the operating conditions affecting the performance of the powertrain;
(x) a sensor-group communication channel adapted to convey information or power between said controller and said sensor group;
(xi) nmax number of engine control leads adapted to convey information between said controller and each said engine;
(xii) nmax number of engine-starter control leads adapted to convey information or power between said controller and each said engine starter;
(xiii) nmax-1 torque-coupler-clutch control leads adapted to convey information between said controller and each said torque-coupler-clutch;
(xiv) nmax-1 torque-coupler-clutch-activator control leads adapted to convey information or power between said controller and each said torque-coupler-clutch activator;
(xv) a battery adapted to provide power for said controller, and through said controller to said engine starters, torque-coupler-clutch activators, sensor group, and user console; and
(xvi) a controller power lead adapted to convey power from said battery to said controller;
where said controller, in a real-time repeating loop:
(a) determines “present power” based on how many said engines are coupled to the powertrain, and the operating conditions of said engines, from information available on said engine control leads and torque-coupler-clutch control leads; and
(b) determines “needed power” from application of said user-adjustable parameters of operation to real-time information from said sensor group whether additional power should be coupled to the powertrain, and, if not, whether surplus power exceeds a user-adjustable “allowance” and therefore should be uncoupled from the powertrain; and
(c) if additional power is needed:
(1) determines the appropriate sequence number n of a next said engine to activate; and
(2) starts said engine n by activation of said engine starter n over said engine-starter control lead n;
when said engine n reaches the proper operating conditions as determined by information on said engine control lead n, and couples the driving power of said engine n to the powertrain by activation of torque-coupler-clutch activator n over torque-coupler-clutch activator control lead n, causing torque-coupler-clutch n to engage; or
(d) if surplus power should be uncoupled from the powertrain:
(1) determines the appropriate sequence number n of a said engine to deactivate;
(2) uncouples the driving power of said engine n from the powertrain by deactivation of said torque-coupler-clutch n over said torque-coupler-clutch control lead n; and
(3) stops said engine n by deactivation over said engine control lead n.

2. The multi-engine powertrain control system apparatus of claim 1, where at least one said engine is an internal-combustion engine.

3. The multi-engine powertrain control system apparatus of claim 1, where at least one said engine is an electric engine or motor.

4. The multi-engine powertrain control system apparatus of claim 1, where at least one said engine is powered by compressed-gas fuel.

5. The multi-engine powertrain control system apparatus of claim 1, where at least one said engine is of a different type from at least one other said engine.

6. The multi-engine powertrain control system apparatus of claim 1, where said torque-coupler-clutch is an electric clutch and drive.

7. The multi-engine powertrain control system apparatus of claim 1, where said torque-coupler-clutch is a hydraulic-mechanical clutch and drive.

8. The multi-engine powertrain control system apparatus of claim 1, where said torque-coupler-clutch is a fluid-drive coupler.

9. The multi-engine powertrain control system apparatus of claim 1, where said sensor group further comprises a sensor monitoring pitch of incline or decline of the vehicle as a factor for determining “needed power.”

10. The multi-engine powertrain control system apparatus of claim 1, further comprising adaptations for military uses of the vehicle, vessel, or powerhouse.

11. A multi-engine powertrain control system method for a vehicle, vessel, or powerhouse having a powertrain, operated by a user, driver, pilot, or operator, the multi-engine powertrain control system method comprising:
(i) providing a multi-engine powertrain control system apparatus comprising:
(a) a primary engine having the sequence number n=1, adapted to drive the powertrain;
(b) at least one additional engine, each having a sequence number n incrementally greater than 1, where nmax equals the total number of engines;
(c) nmax number of engine starters, each associated with one said engine;
(d) nmax-1 number of torque-coupler-clutches, each associated with one said additional engine, adapted to couple and uncouple the driving power of each associated said additional engine to the powertrain;
(e) nmax-1 number of torque-coupler-clutch activators, each associated with one said torque-coupler-clutch, adapted to change the coupled or uncoupled state of each associated said torque-coupler-clutch;
(f) a controller adapted to sense the powertrain's conditions and control said additional engines, engine starters, torque-coupler-clutches, and torque-coupler-clutch activators, in real time, based on powertrain conditions and user-adjustable parameters of operation;
(g) a user console adapted to display information to and accept commands from a user in real time;
(h) a user-console communication channel adapted to convey information or power between said controller and said user console;
(i) a sensor group adapted to monitor the performance of the powertrain and the operating conditions affecting the performance of the powertrain;
(j) a sensor-group communication channel adapted to convey information or power between said controller and said sensor group;
(k) nmax number of engine control leads adapted to convey information between said controller and each said engine;
(l) nmax number of engine-starter control leads adapted to convey information or power between said controller and each said engine starter;
(m) nmax-1 torque-coupler-clutch control leads adapted to convey information between said controller and each said torque-coupler-clutch;
(n) nmax-1 torque-coupler-clutch-activator control leads adapted to convey information or power between said controller and each said torque-coupler-clutch activator;
(o) a battery adapted to provide power for said controller, and through said controller to said engine starters, torque-coupler-clutch activators, sensor group, and user console; and
(p) a controller power lead adapted to convey power from said battery to said controller;
where said controller, in a real-time repeating loop:
(1) determines how many said engines are coupled to the powertrain, and the operating conditions of said engines, from information available on said engine control leads and torque-coupler-clutch control leads; and
(2) determines from application of said user-adjustable parameters of operation to real-time information from said sensor group whether additional power should be coupled to the powertrain, and, if not, whether surplus power should be uncoupled from the powertrain; and
(3) if additional power is needed:
(A) determines the appropriate sequence number n of a next said engine to activate; and
(B) starts said engine n by activation of said engine starter n over said engine-starter control lead n;
when said engine n reaches the proper operating conditions as determined by information on said engine control lead n, couples the driving power of said engine n to the powertrain by activation of torque-coupler-clutch activator n over torque-coupler-clutch activator control lead n, causing torque-coupler-clutch n to engage; or
(4) if surplus power should be uncoupled from the powertrain:
(A) determines the appropriate sequence number n of a said engine to deactivate;
(B) uncouples the driving power of said engine n from the powertrain by deactivation of said torque-coupler-clutch n over said torque-coupler-clutch control lead n; and
(C) stops said engine n by deactivation over said engine control lead n.

12. The multi-engine powertrain control system method of claim 11, where at least one said engine is an internal-combustion engine.

13. The multi-engine powertrain control system method of claim 11, where at least one said engine is an electric engine or motor.

14. The multi-engine powertrain control system method of claim 11, where at least one said engine is powered by compressed-gas fuel.

15. The multi-engine powertrain control system method of claim 11, where at least one said engine is of a different type from at least one other said engine.

16. The multi-engine powertrain control system method of claim 11, where said torque-coupler-clutch is an electric clutch and drive.

17. The multi-engine powertrain control system method of claim 11, where said torque-coupler-clutch is a hydraulic-mechanical clutch and drive.

18. The multi-engine powertrain control system method of claim 11, where said torque-coupler-clutch is a fluid-drive coupler.

19. The multi-engine powertrain control system method of claim 11, where said sensor group further comprises a sensor monitoring pitch of incline or decline of the vehicle as a factor for determining “needed power.”

20. The multi-engine powertrain control system method of claim 11, further comprising adaptations for military uses of the vehicle, vessel, or powerhouse.

21. A multi-engine powertrain control system apparatus for a vehicle, vessel, or powerhouse having a powertrain, operated by a user, driver, pilot, or operator, the multi-engine powertrain control system comprising:
(i) a primary engine having the sequence number n=1, adapted to drive the powertrain;
(ii) at least one additional engine, each having a sequence number n incrementally greater than 1, where nmax equals the total number of engines;
(iii) nmax number of engine starters, each associated with one said engine;
(iv) nmax-1 number of torque-coupler-clutches, each associated with one said additional engine, adapted to couple and uncouple the driving power of each associated said additional engine to the powertrain;
(v) nmax-1 number of torque-coupler-clutch activators, each associated with one said torque-coupler-clutch, adapted to change the coupled or uncoupled state of each associated said torque-coupler-clutch;
(vi) a controller adapted to sense the powertrain's conditions and control said additional engines, engine starters, torque-coupler-clutches, and torque-coupler-clutch activators, in real time, based on powertrain conditions and user-adjustable parameters of operation;
(vii) a user console adapted to display information to and accept commands from a user in real time;
(viii) a user-console communication channel adapted to convey information and power between said controller and said user console;
(ix) a sensor group adapted to monitor the performance of the powertrain and the operating conditions affecting the performance of the powertrain;
(x) a sensor-group communication channel adapted to convey information and power between said controller and said sensor group;
(xi) nmax number of engine control leads adapted to convey information between said controller and each said engine;
(xii) nmax number of engine-starter control leads adapted to convey information and power between said controller and each said engine starter;
(xiii) nmax-1 torque-coupler-clutch control leads adapted to convey information between said controller and each said torque-coupler-clutch;
(xiv) nmax-1 torque-coupler-clutch-activator control leads adapted to convey information and power between said controller and each said torque-coupler-clutch activator;
(xv) a battery adapted to provide power for said controller, and through said controller to said engine starters, torque-coupler-clutch activators, sensor group, and user console; and
(xvi) a controller power lead adapted to convey power from said battery to said controller;
where said controller, in a real-time repeating loop:
(a) determines “present power” based on how many said engines are coupled to the powertrain, and the operating conditions of said engines, from information available on said engine control leads and torque-coupler-clutch control leads; and
(b) determines “needed power” from application of said user-adjustable parameters of operation to real-time information from said sensor group whether additional power should be coupled to the powertrain, and, if not, whether surplus power exceeds a user-adjustable “allowance” and therefore should be uncoupled from the powertrain; and
(c) if additional power is needed:
(1) determines the appropriate sequence number n of a next said engine to activate; and
(2) starts said engine n by activation of said engine starter n over said engine-starter control lead n;
when said engine n reaches the proper operating conditions as determined by information on said engine control lead n, and couples the driving power of said engine n to the powertrain by activation of torque-coupler-clutch activator n over torque-coupler-clutch activator control lead n, causing torque-coupler-clutch n to engage; or
(d) if surplus power should be uncoupled from the powertrain:
(1) determines the appropriate sequence number n of a said engine to deactivate;
(2) uncouples the driving power of said engine n from the powertrain by deactivation of said torque-coupler-clutch n over said torque-coupler-clutch control lead n; and
(3) stops said engine n by deactivation over said engine control lead n.

22. The multi-engine powertrain control system apparatus of claim 21, where at least one said engine is an internal-combustion engine.

23. The multi-engine powertrain control system apparatus of claim 21, where at least one said engine is an electric engine or motor.

24. The multi-engine powertrain control system apparatus of claim 21, where at least one said engine is powered by compressed-gas fuel.

25. The multi-engine powertrain control system apparatus of claim 21, where at least one said engine is of a different type from at least one other said engine.

26. The multi-engine powertrain control system apparatus of claim 21, where said torque-coupler-clutch is an electric clutch and drive.

27. The multi-engine powertrain control system apparatus of claim 21, where said torque-coupler-clutch is a hydraulic-mechanical clutch and drive.

28. The multi-engine powertrain control system apparatus of claim 21, where said torque-coupler-clutch is a fluid-drive coupler.

29. The multi-engine powertrain control system apparatus of claim 21, where said sensor group further comprises a sensor monitoring pitch of incline or decline of the vehicle as a factor for determining “needed power.”

30. The multi-engine powertrain control system apparatus of claim 21, further comprising adaptations for military uses of the vehicle, vessel, or powerhouse.

31. A multi-engine powertrain control system method for a vehicle, vessel, or powerhouse having a powertrain, operated by a user, driver, pilot, or operator, the multi-engine powertrain control system method comprising:
(i) providing a multi-engine powertrain control system apparatus comprising:
(a) a primary engine having the sequence number n=1, adapted to drive the powertrain;
(b) at least one additional engine, each having a sequence number n incrementally greater than 1, where nmax equals the total number of engines;
(c) nmax number of engine starters, each associated with one said engine;
(d) nmax-1 number of torque-coupler-clutches, each associated with one said additional engine, adapted to couple and uncouple the driving power of each associated said additional engine to the powertrain;
(e) nmax-1 number of torque-coupler-clutch activators, each associated with one said torque-coupler-clutch, adapted to change the coupled or uncoupled state of each associated said torque-coupler-clutch;
(f) a controller adapted to sense the powertrain's conditions and control said additional engines, engine starters, torque-coupler-clutches, and torque-coupler-clutch activators, in real time, based on powertrain conditions and user-adjustable parameters of operation;
(g) a user console adapted to display information to and accept commands from a user in real time;
(h) a user-console communication channel adapted to convey information and power between said controller and said user console;
(i) a sensor group adapted to monitor the performance of the powertrain and the operating conditions affecting the performance of the powertrain;
(j) a sensor-group communication channel adapted to convey information and power between said controller and said sensor group;
(k) nmax number of engine control leads adapted to convey information between said controller and each said engine;
(l) nmax number of engine-starter control leads adapted to convey information and power between said controller and each said engine starter;
(m) nmax-1 torque-coupler-clutch control leads adapted to convey information between said controller and each said torque-coupler-clutch;
(n) nmax-1 torque-coupler-clutch-activator control leads adapted to convey information and power between said controller and each said torque-coupler-clutch activator;
(o) a battery adapted to provide power for said controller, and through said controller to said engine starters, torque-coupler-clutch activators, sensor group, and user console; and
(p) a controller power lead adapted to convey power from said battery to said controller;
where said controller, in a real-time repeating loop:
(1) determines how many said engines are coupled to the powertrain, and the operating conditions of said engines, from information available on said engine control leads and torque-coupler-clutch control leads; and
(2) determines from application of said user-adjustable parameters of operation to real-time information from said sensor group whether additional power should be coupled to the powertrain, and, if not, whether surplus power should be uncoupled from the powertrain; and
(3) if additional power is needed:
(A) determines the appropriate sequence number n of a next said engine to activate; and
(B) starts said engine n by activation of said engine starter n over said engine-starter control lead n;
when said engine n reaches the proper operating conditions as determined by information on said engine control lead n, couples the driving power of said engine n to the powertrain by activation of torque-coupler-clutch activator n over torque-coupler-clutch activator control lead n, causing torque-coupler-clutch n to engage; or
(4) if surplus power should be uncoupled from the powertrain:
(A) determines the appropriate sequence number n of a said engine to deactivate;
(B) uncouples the driving power of said engine n from the powertrain by deactivation of said torque-coupler-clutch n over said torque-coupler-clutch control lead n; and
(C) stops said engine n by deactivation over said engine control lead n.

32. The multi-engine powertrain control system method of claim 31, where at least one said engine is an internal-combustion engine.

33. The multi-engine powertrain control system method of claim 31, where at least one said engine is an electric engine or motor.

34. The multi-engine powertrain control system method of claim 31, where at least one said engine is powered by compressed-gas fuel.

35. The multi-engine powertrain control system method of claim 31, where at least one said engine is of a different type from at least one other said engine.

36. The multi-engine powertrain control system method of claim 31, where said torque-coupler-clutch is an electric clutch and drive.

37. The multi-engine powertrain control system method of claim 31, where said torque-coupler-clutch is a hydraulic-mechanical clutch and drive.

38. The multi-engine powertrain control system method of claim 31, where said torque-coupler-clutch is a fluid-drive coupler.

39. The multi-engine powertrain control system method of claim 31, where said sensor group further comprises a sensor monitoring pitch of incline or decline of the vehicle as a factor for determining “needed power.”

40. The multi-engine powertrain control system method of claim 31, further comprising adaptations for military uses of the vehicle, vessel, or powerhouse.
